(19) United States
(12) Patent Application Publication
(10) Pub. No.: US 2011/0005159 A1
(43) Pub. Date: Jan. 13, 2011

(54) LAMINATED WOOD FLOORING STRIP AND WOOD FLOOR

(76) Inventor: TAI-TZUNG LEE, Kaohsiung City (TW)

Correspondence Address: SINORICA, LLC, 2275 Research Blvd., Suite 500, ROCKVILLE, MD, 20850, US

(21) Appl. No.: 12/499,865

(22) Filed: Jul. 9, 2009

(51) Int. Cl. E04C 2/24; E04C 2/38; B32B 3/26

(52) U.S. Cl. 52/588.1; 428/304.4; 428/319.7

(57) ABSTRACT

A wood flooring strip for assembly into a wood floor is provided. The wood flooring strip includes a top layer; a bottom layer; at least one intermediate layer positioned between the top layer and the bottom layer; a veneer formed on the top layer; a transparent layer formed on the veneer; and a foam layer adhered to a bottom of the bottom layer.

### BACKGROUND OF THE INVENTION

1. Field of Invention

The invention relates to wood flooring and more particularly to an improved laminated wood flooring strip for assembly into a wood floor.

2. Description of Related Art

Laminated wood floors are well known in the art. One problem of the conventional laminated wood floors is that a laminated wood floor may expand or contract when moisture and temperature change in the atmosphere.

Another problems associated with the conventional laminated wood floors are that they are often subject to warping, twisting and cupping, thereby requiring replacement to refurbish.

Still another problems associated with the conventional laminated wood floors made of plastic are that they are poor in quality, not durable, and not environmentally friendly.

There have been numerous suggestions in prior patents for laminated wood flooring strip and wood floor. For example, U.S. Pat. No. 5,736,227 discloses a laminated wood flooring product and wood floor. Thus, continuing improvements in the exploitation of laminated wood flooring strip and wood floor are constantly being sought.

### SUMMARY OF THE INVENTION

It is therefore one object of the invention to provide a laminated wood flooring strip for assembly into a wood floor.

The above and other objects, features and advantages of the invention will become apparent from the following detailed description taken with the accompanying drawings.

### BRIEF DESCRIPTION OF THE DRAWINGS

FIG. 1 is a perspective view of a wood flooring strip according to a first preferred embodiment of the invention;

FIG. 2 is an exploded view of the wood flooring strip;

FIG. 3 is a longitudinal sectional view of the wood flooring strip shown in FIG. 1;

FIG. 4 is an exploded view of six wood flooring strips of the invention to be assembled into a wood floor;

FIG. 5 is a perspective view of the assembled wood flooring strips shown in FIG. 4;

FIG. 6 is a perspective view of a wood flooring strip according to a second preferred embodiment of the invention; and

FIG. 7 is a perspective view of four wood flooring strips shown in FIG. 6 being assembled together.

### DETAILED DESCRIPTION OF THE INVENTION

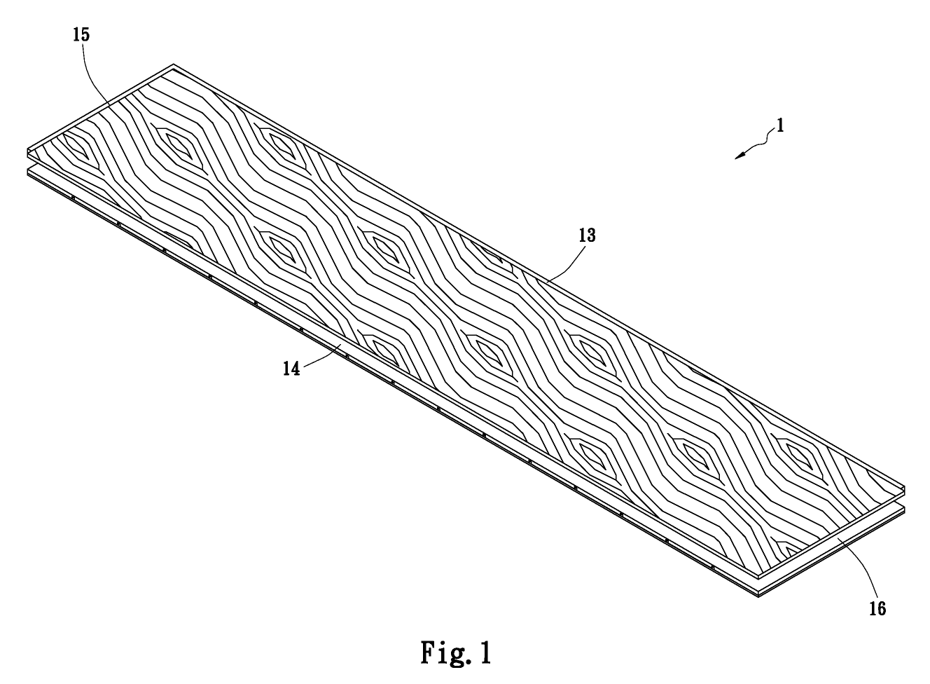

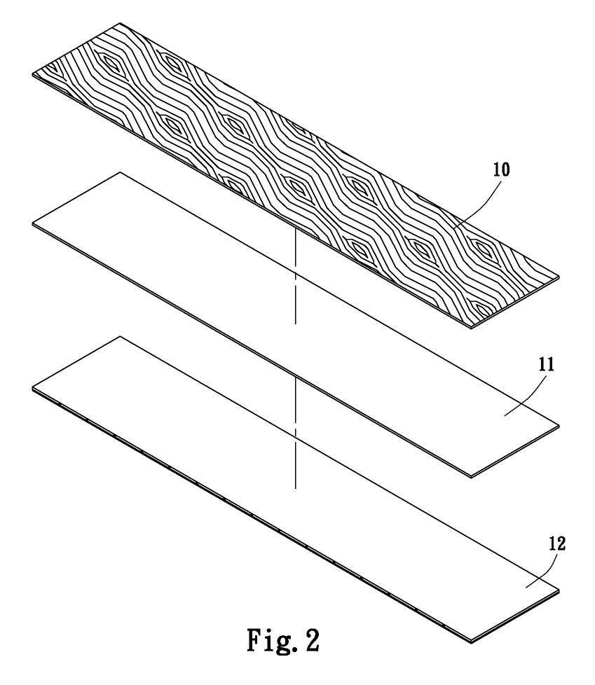

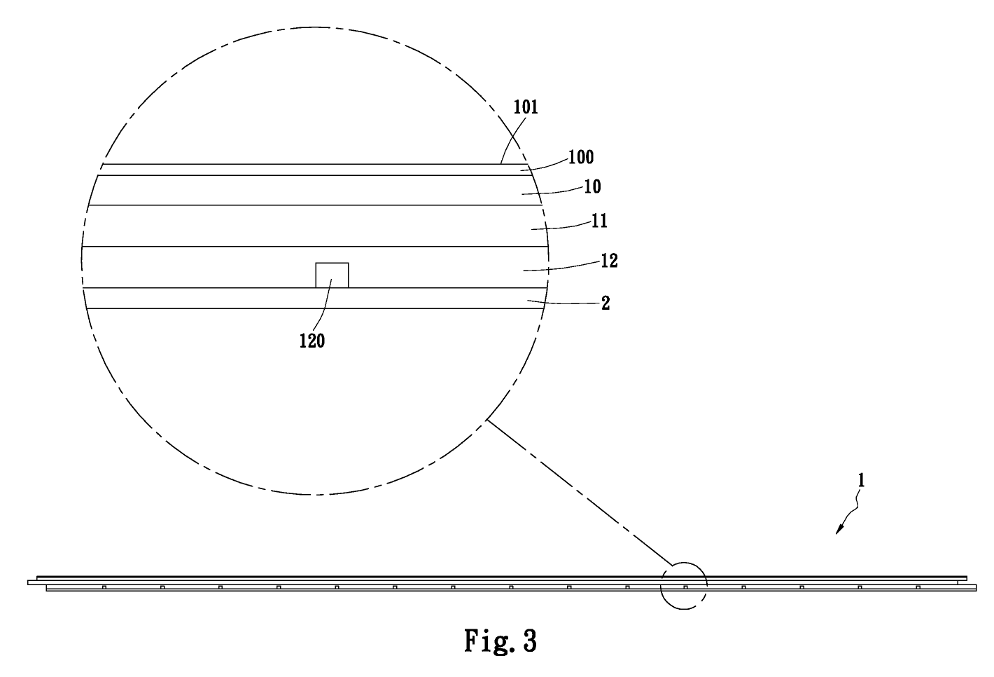

Referring to FIGS. 1 to 3, a laminated wood flooring strip 1 in accordance with a first preferred embodiment of the invention is shown. The wood flooring strip 1 is rectangular in this embodiment or square in other embodiments. The wood flooring strip 1 is made of plywood or wood. The wood flooring strip 1 comprises the following components as discussed in detail below.

A top layer 10, at least one intermediate layer (one is shown) 11, and a bottom layer 12 are bonded together. The intermediate layer 11 has a first tongue 13 extending along one side by machining, a first groove 14 extending along the other side by machining, a second tongue 15 extending along one end by machining, and a second groove 16 extending along the other end by machining. A veneer 100 of PVC (polyvinyl chloride) is coated on the top layer 10. The veneer 100 has an aesthetic pattern formed thereon. A transparent layer 101 is coated on the veneer 100. The transparent layer 101 is also waterproof and can protect the veneer 100 thereunder.

The intermediate layer 11 can increase thickness of the wood flooring strip 1. In another configuration of this embodiment, two or more intermediate layers 11 can be included to form a four or more-layer laminated wood flooring strip. The bottom layer 12 has a plurality of cavities 120 on the bottom. The cavities 120 provide a space to allow the bottom layer 12 to expand when moisture and temperature change in the atmosphere. As a result, the wood flooring strip 1 can be durable. A layer 2 made of foam is adhered to the bottom of the bottom layer 12. The foam layer 2 may act as a buffer of the wood flooring strip 1. The foam layer 2 is adhered to a supporting subfloor (not shown) when a plurality of the wood flooring strips 1 are assembled into a wood floor as detailed later.

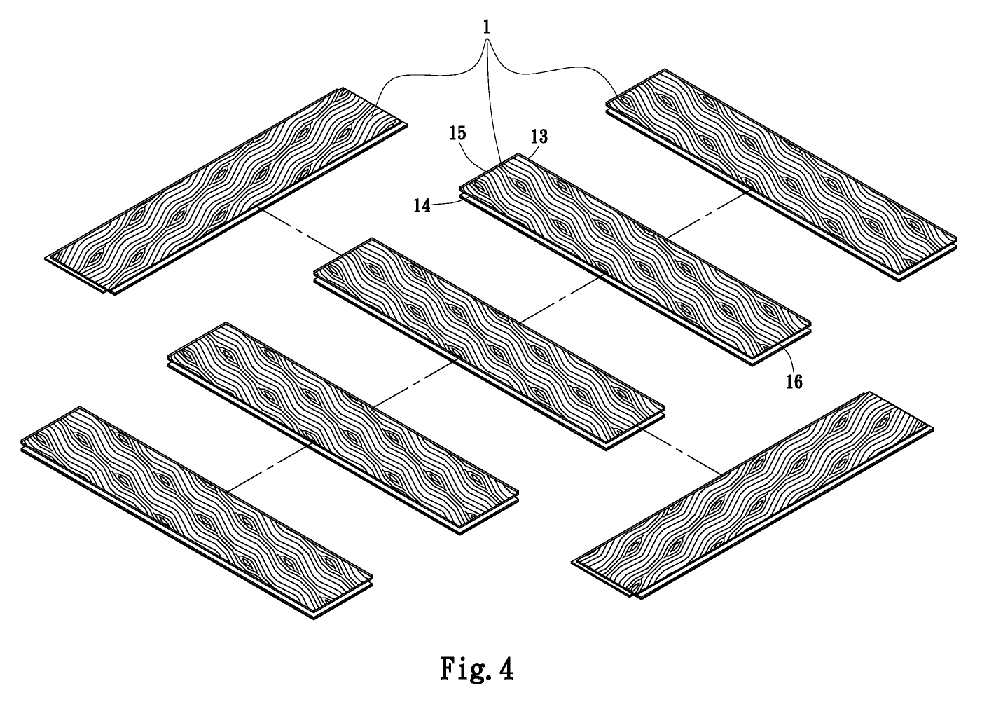

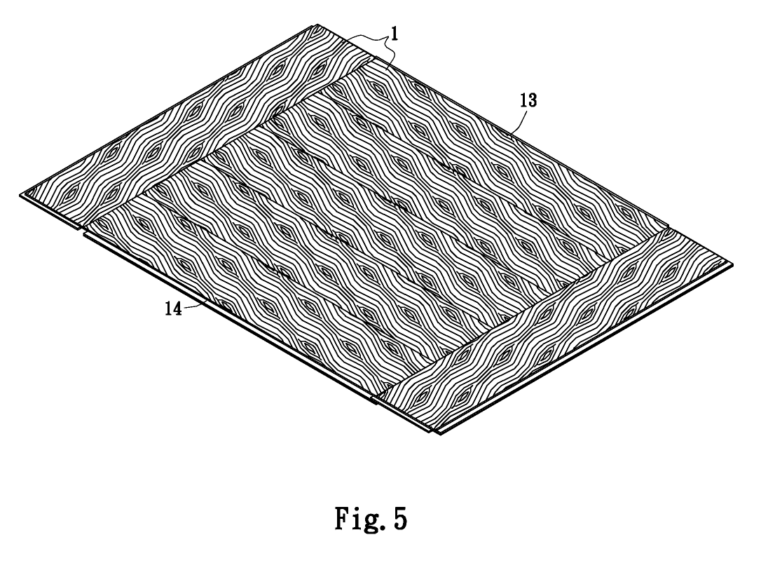

Referring to FIGS. 4 and 5, when a plurality of laminated wood flooring strips 1 are assembled together, the first groove 14 of one laminated wood flooring strip 1 will mate with the first tongue 13 of the adjacent laminated wood flooring strip 1. Also, the first groove 14 of one laminated wood flooring strip 1 will mate with the second tongues 15 of the already assembled wood flooring strips 1. Further, the first tongue 13 of another laminated wood flooring strip 1 will mate with the second grooves 16 of the already assembled wood flooring strips 1. As a result, a wood floor is formed.

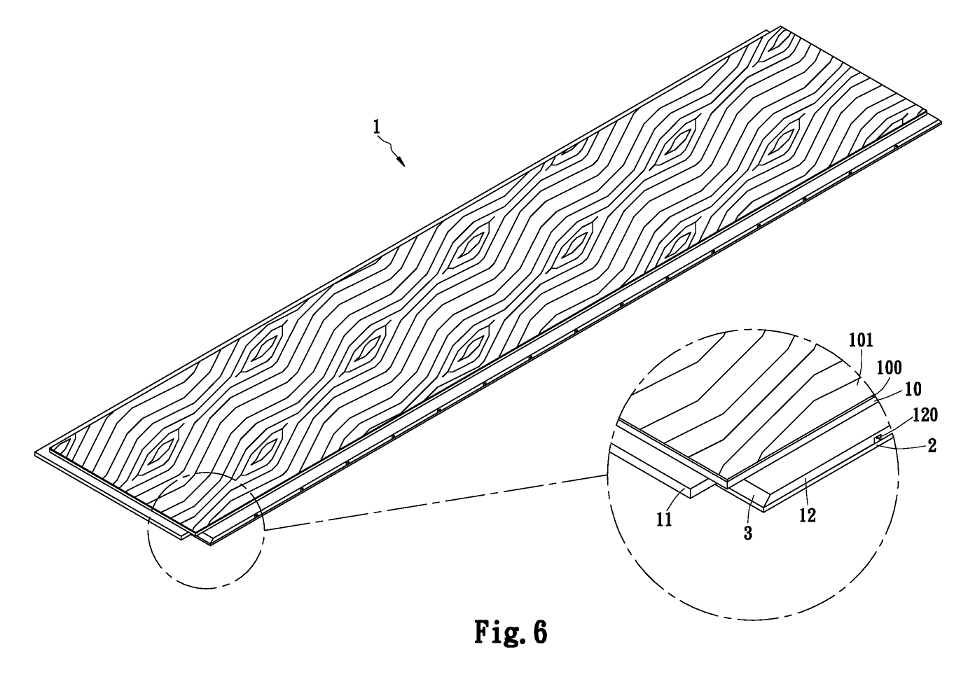

Referring to FIG. 6, a laminated wood flooring strip 1 in accordance with a second preferred embodiment of the invention is shown. The second embodiment is identical to the first embodiment, except that a bottom layer 12 of the wood flooring strip 1 has an inclined surface 3 on either end.

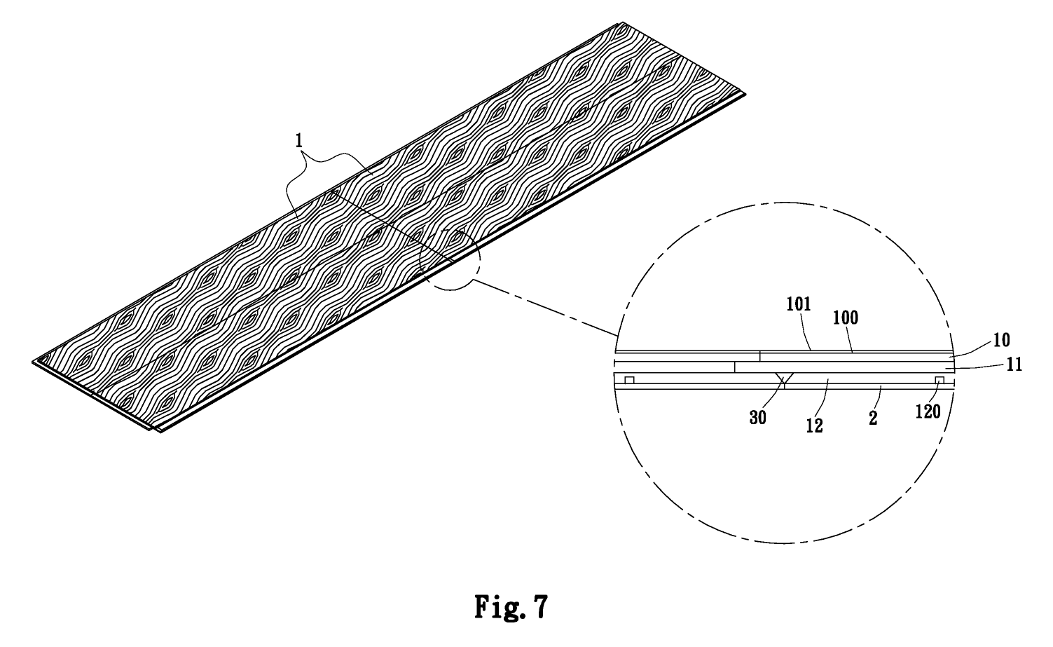

Referring to FIG. 7, a plurality of (four are shown) laminated wood flooring strips 1 are assembled together to form a wood floor by bonding. It is shown that a V-shaped gap 30 is formed between facing ends of two adjacent laminated wood flooring strips 1. The V-shaped gap 30 provides a space to allow the bottom layer 12 to expand when moisture and temperature change in the atmosphere. As a result, the wood flooring strip 1 can be durable.

While the invention herein disclosed has been described by means of specific embodiments, numerous modifications and variations could be made thereto by those skilled in the art without departing from the scope and spirit of the invention set forth in the claims.

What is claimed is:

1. A wood flooring strip for assembly into a wood floor, the wood flooring strip comprising:
a top layer;
a bottom layer;
at least one intermediate layer positioned between the top layer and the bottom layer;
a veneer formed on the top layer;
a transparent layer formed on the veneer; and
a foam layer adhered to a bottom of the bottom layer.

2. The wood flooring strip of claim 1, wherein the at least one intermediate layer comprises a first tongue at one side, a first groove at the other side, a second tongue at one end, and a second groove at the other end.

3. The wood flooring strip of claim 1, wherein each of the top layer, the bottom layer, and the at least one intermediate layer is formed of plywood.

4. The wood flooring strip of claim 1, wherein each of the top layer, the bottom layer, and the at least one intermediate layer is formed of wood.

5. The wood flooring strip of claim 1, wherein the veneer is formed of PVC.

6. The wood flooring strip of claim 1, wherein the veneer has a pattern.

7. The wood flooring strip of claim 1, wherein the number of the at least one intermediate layer is one.

8. The wood flooring strip of claim 1, wherein the number of the at least one intermediate layer is two or more.

9. The wood flooring strip of claim 1, wherein the bottom layer comprises a plurality of cavities on the bottom thereof.

10. The wood flooring strip of claim 1, wherein the bottom layer comprises an inclined surface on either end.
